(19) United States
(12) Patent Application Publication
(10) Pub. No.: US 2006/0162252 A1
(43) Pub. Date: Jul. 27, 2006

(54) Hydroponic device and hydroponic pot thereof

(76) Inventor: Sun-Ho Lim, Chenranam-do (KR)

Correspondence Address: Luce Forward;Hamilton & Scripps, Suite 200, 11988 El Camino Real, San Diego, CA, 92130, US

(21) Appl. No.: 10/535,727

(22) PCT Filed: Nov. 25, 2003
(86) PCT No.: PCT/KR02/02567

§ 371 Date: May 20, 2005

(30) Foreign Application Priority Data
Nov. 27, 2002 (KR) 20-2002-0035420
Jan. 10, 2003 (KR) 20-2003-0000771
Nov. 21, 2003 (KR) 20-2003-0036369

(51) Int. Cl. A01G 31/04

(52) U.S. Cl. 47/59 R

(57) ABSTRACT

A nutriculture device and a stack-type nutriculture pot system for use in the nutriculture device are disclosed. The nutriculture vice includes moving means for periodically moving a plurality of nutriculture pots, each having culture soil for supporting a crop, on a predetermined closed loop type moving track, a spray nozzle installed at a location on the moving track of the nutriculture pots, for supplying a nutrient solution to the nutriculture pot passing through the location, and a nutrient solution recovery channel for recovering the nutrient solution flowing from the nutriculture pot. Since the above-described nutriculture device supplies a nutrient solution to a plurality of nutriculture pots using a single spray nozzle, its construction can be noticeably simplified. Also, since a nutriculture pot moves periodically so that its location in a houseplant changes at any time, an amount of sunshine applied to a crop is uniformly maintained, allowing the crop to grow evenly.

### TECHNICAL FIELD

The present invention relates to a nutrient culture device and a stack-type nutrient culture pot system used in the nutrient culture device.

### BACKGROUND ART

Nutrient culture technique, abbreviated as “nutriculture”, represents cultivation of crops in an aqueous solution prepared by dissolving essential elements needed by crops for their normal growth and development in water in appropriate concentrations according to their absorption ratios, the aqueous solution being referred to as a “nutrient solution” hereinafter. According to the nutriculture, kinds of nutrient solutions and conditions of root support media can be optionally controlled in an elaborate way. Thus, the nutriculture is regarded as a scientific farming technique, which can optimize growth of crops by uniformly maintaining growth conditions and environments.

Nutriculture is largely classified into aeroponic culture, water culture and solid medium culture according to the kind of medium used. Specifically, in the solid medium culture, which is currently in the most widespread use, crops are supported using solid media (hereinafter to be referred to as “culture soil”) prepared from sand, perlite, rockwool, gravel, chaff, husk charcoal, etc., instead of natural soil, and nutrient solutions are supplied to the crops.

An example of conventional solid medium culture equipment is taught in Korean Patent Application No. 1992-13535, in which nutriculture pots are provided on nutriculture beds installed at ridges in a greenhouse plant and every nutriculture pot requires each nutrient irrigation facility, requiring a substantial investment in facilities and equipment. Another example of conventional nutriculture devices is disclosed in Korean Patent Application No. 2000-20483, in which an external vessel formed of styrofoam having matrix-type weep holes has a built-in internal vessel containing natural soil, instead of culture soil. Korean Utility Model Application No. 2001-22173 discloses a method of sprinkling a nutrient solution using a nozzle provided at an upper portion of a pot installed in a hydroponic culture bed. However, the conventional nutriculture devices presented several drawbacks. For example, it is necessary to install a nutrient solution sprinkler duct at an appropriate position for every nutriculture pot.

Also, location and space limitations often restrict the practice of the conventional nutriculture devices. That is, a height of a nutriculture pot cannot be arbitrarily adjusted in consideration of characteristics of crops, and it impossible to uniformly control the amount of sunshine. Further, such conventional nutriculture devices are disadvantageous in view of feeding and draining because nutrient solutions are separately supplied to individual nutriculture pots.

### DISCLOSURE OF THE INVENTION

The present invention provides a nutriculture device which has a simplified structure and can be relatively cost-effectively installed, and a nutriculture pot thereof.

The present invention also provides a nutriculture device which can cultivate a crop in high densities even with space limitations and can contribute to uniform growth of the crop, and a nutriculture pot thereof.

Also, the present invention provides a nutriculture device by which feeding and draining of a nutrient solution can be efficiently performed, and a nutriculture pot thereof.

In accordance with an aspect of the present invention, there is provided a stack-type nutriculture pot system comprises a plurality of stacked nutriculture pots containing culture soil for supporting a crop. Each of the plurality of nutriculture pots is shaped of a cylinder having open upper and lower ends, and a lower network for supporting culture soil is formed at a lower portion of the nutriculture pot, so that a nutrient solution supplied from an upper portion of the stack-type nutriculture pot system is delivered from the uppermost nutriculture pot to the lowermost nutriculture pot. Crop growth units are formed at one or more lateral surfaces of each nutriculture pot.

In the above-described stack-type nutriculture pot system, the number of stacks of nutriculture pots can be arbitrarily adjusted according to a ceiling height of a houseplant. Thus, since the number of stacked columns of nutriculture pots is arbitrarily adjusted, so that the houseplant can be utilized in a space-efficient manner, thereby allowing high-density cultivation.

In accordance with another aspect of the present invention, there is provided a stack-type nutriculture pot system formed by stacking a plurality of nutriculture pots each having culture soil for support a crop, wherein each of the plurality of nutriculture pots is shaped of a cylinder having a rectangular cross section and having an upper end opened and a lower end closed, and has one or more nutrient supply ducts penetrate a bottom surface thereof to be installed substantially perpendicularly, so that the nutrient supply ducts of two vertically neighboring nutriculture pots are connected to each other when stacking the plurality of nutriculture pots. An outlet is provided at a connection portion between two neighboring nutrient supply ducts so that a nutrient solution contained in the nutrient supply duct flows out therethrough. Crop growth units are formed at one or more lateral surfaces of the nutriculture pot.

In accordance with still another aspect of the present invention, there is provided a nutriculture device comprising moving means for periodically moving a plurality of nutriculture pots, each having culture soil for supporting a crop, on a predetermined closed loop type moving track, a spray nozzle installed at a location on the moving track of the nutriculture pots, for supplying a nutrient solution to the nutriculture pot passing through the location, and a nutrient solution recovery channel for recovering the nutrient solution flowing from the nutriculture pot.

Since the above-described nutriculture device supplies a nutrient solution to a plurality of nutriculture pots using a single spray nozzle, its construction can be noticeably simplified. Also, since a nutriculture pot moves periodically so that its location in a houseplant changes at any time, an amount of sunshine applied to a crop is uniformly maintained, allowing the crop to grow evenly.

### BRIEF DESCRIPTION OF THE DRAWINGS

FIG. 1 is a schematic diagram of a nutriculture device according to the present invention;

FIG. 2 is a perspective view illustrating essential parts of a nutriculture device according to an embodiment of the present invention;

FIG. 3 is a plan view of the nutriculture device shown in FIG. 2;

FIGS. 4 and 5 partly exploded perspective views illustrating a chain conveyor of the nutriculture device shown in FIG. 2;

FIG. 6 is a perspective view of distance adjusting means of the nutriculture device shown in FIG. 2;

FIGS. 7 and 8 are perspective views illustrating installation structures of nutriculture pots in nutriculture devices according to another embodiments of the present invention;

FIG. 9 is a plan view of a nutriculture device according to still another embodiment of the present invention;

FIG. 10 is a cross-sectional view of FIG. 9 taken along the line “A-A”;

FIG. 11 is a partly exploded perspective view of the nutriculture device shown in FIG. 9;

FIG. 12 is a partly exploded perspective view of a nutriculture device according to yet another embodiment of the present invention;

FIG. 13 is a fragmentary perspective view illustrating a structure in which a nutriculture pot is seated on the nutriculture device shown in FIG. 12;

FIG. 14 is a perspective view of a stack-type nutriculture pot system according to an embodiment of the present invention;

FIG. 15 is a cross-sectional view of the stack-type nutriculture pot system shown in FIG. 14;

FIG. 16 is a perspective view illustrating each nutriculture pot of the stack-type nutriculture pot system shown in FIG. 14;

FIG. 17 is a perspective view illustrating an upper cover or a lower cover of the stack-type nutriculture pot system shown in FIG. 14;

FIGS. 18 and 19 are perspective views illustrating another examples of each nutriculture pot of the stack-type nutriculture pot system according to the present invention;

FIG. 20 is a perspective view illustrating a stack-type nutriculture pot system according to another embodiment of the present invention;

FIG. 21 is a cross-sectional view of a nutriculture pot shown in FIG. 20; and

FIG. 22 is an extracted perspective view illustrating a connection state of a nutrient supply duct of the nutriculture pot shown in FIG. 20.

### BEST MODE FOR CARRYING OUT THE INVENTION

The present invention will now be described in more detail with reference to the following embodiments. However, the following embodiments are provided for illustration only and the invention should not be construed as being limited to the embodiments set forth herein.

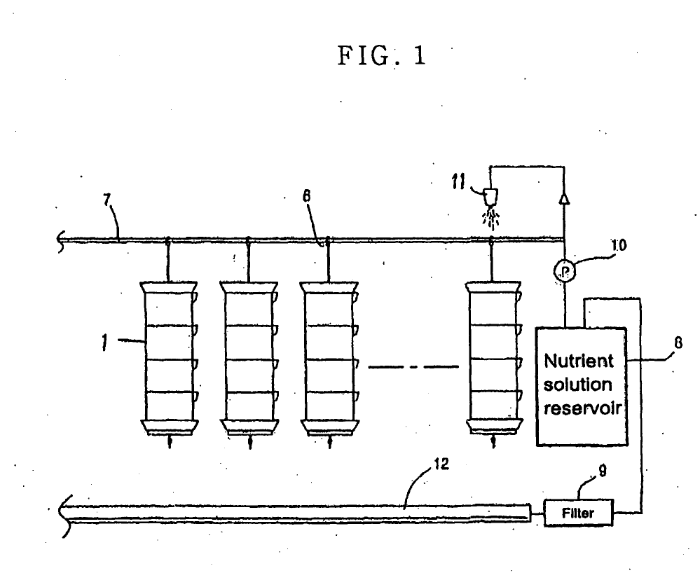

As shown in FIG. 1, in a nutriculture device according to the present invention, a plurality of nutriculture pots 1 are hung on a conveyor 7 by ropes 6 at a predetermined interval and move along a predetermined closed loop type moving track. A nutrient solution recovery channel 12 is disposed in the lower portion of the track of the conveyor 7 installed in the houseplant. The nutrient solution recovery channel 12 is connected to a nutrient spray nozzle 11 via a filter 9, a nutrient solution reservoir 8 and a pump 10. A nutrient solution discharged from the nutriculture pot 1 is recovered from the nutrient solution recovery channel 12 and filtered by the filter 9 to then be stored in the nutrient solution reservoir 8. For spraying a nutrient solution, the nutrient solution stored in the nutrient solution reservoir 9 is pumped by the pump 10 and is supplied to the nutriculture pot 1 through a spray nozzle 11 under which the nutriculture pot 1 passes by.

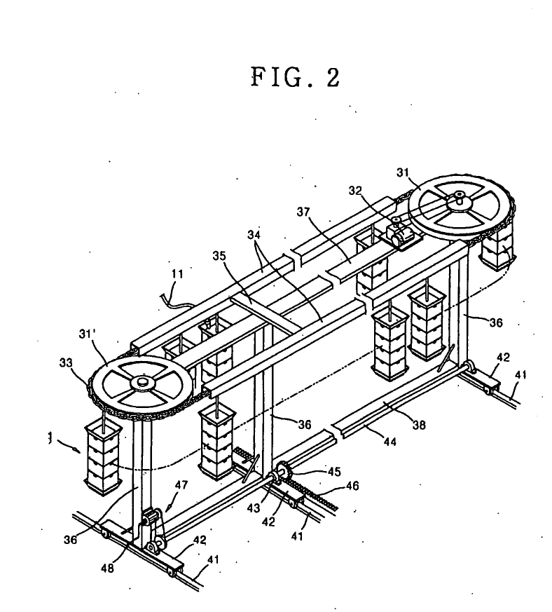

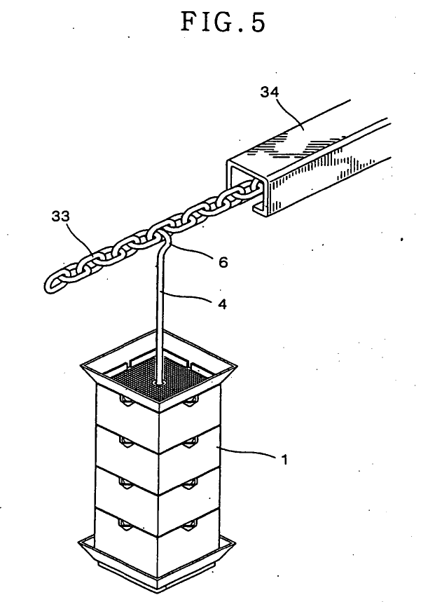

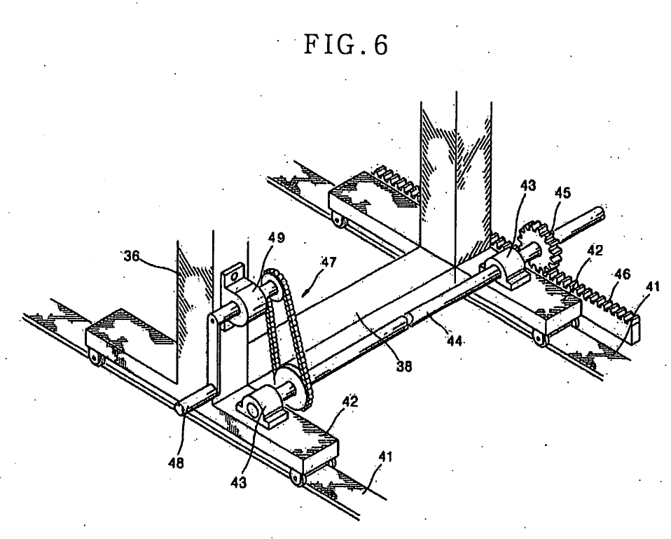

Referring to FIGS. 2 through 6, a nutriculture device 100 according to an embodiment of the present invention includes moving means for periodically moving a plurality of nutriculture pots 1 on a predetermined track, a spray nozzle 11 for supplying a nutrient solution to the nutriculture pot 1, and a nutrient solution recovery channel 12 for recovering the nutrient solution flowing from the nutriculture pot 1.

The moving means is a closed loop type chain conveyor system. The closed loop type chain conveyor system includes power transmission means including two chain wheels 31, 31′ installed at opposite ends thereof, that is, a driving chain wheel and a driven chain wheel, a chain 33 hoisted on teeth 31a about the chain wheels 31, 31′, and a motor 32 for supplying power to the driving chain wheel 31.

The chain wheels 31, 31′ are connected to each other by a horizontal prop 37 on which the motor 32 is mounted, and two “C”-shaped pipes 34 extending substantially in parallel with the horizontal prop 37, which will later be described, are installed to guide movement of the chain 33. Also, the “C”-shaped pipes 34 are connected to each other by a plurality of vertical props 35, although only a single unit is shown in the drawing, spaced a predetermined distance apart from each other. The chain wheels 31, 31′ and the vertical props 35 are fixed on a bottom prop 38 installed under the chain conveyor system by a plurality of perpendicular props 36 spaced a predetermined distance apart from each other. The bottom prop 38 includes conveyor distance adjusting means.

As shown in FIG. 2, the closed loop type chain conveyor 100 may include a plurality of conveyor sets as long as a space of a houseplant permits. The plurality of chain conveyors 100 is arranged in a direction “X” substantially perpendicular to a direction “Y” in which the nutriculture pot 1 moves. As described above, in the case where a plurality of chain conveyors 100 are disposed adjacent to one another in the house plant, distance adjusting means for adjusting a distance D between two neighboring chain conveyors may be provided.

The distance adjusting means is configured to move the chain conveyor 100 in the direction “X”. In more detail, a plurality of rails 41 are disposed on the ground of a houseplant in the direction “X” and a plurality of roller members 42 are installed beneath a bottom prop 38 of the chain conveyor 100. The roller members 42 are configured to roll along the rails 41. In order to provide the chain conveyor 100 with a driving force in the direction “X”, support bodies 43 are installed on the roller members 42, respectively, and a shaft 44 having a length corresponding to that of the conveyor is inserted into two neighboring support bodies 43 so as to be parallel with the bottom prop 38. A pinion gear 45 rotating integrally with the shaft 44 is fixedly installed on a predetermined position of the shaft 44, and the pinion gear 45 is engaged with a rack gear 46 disposed thereunder. A handle 48 is supported by a support body 49 fixed on the outermost perpendicular prop 36 of the chain conveyor 100. Gear connection means 47 for transferring a rotation force of the handle 48 is provided between the handle 48 and the shaft 38.

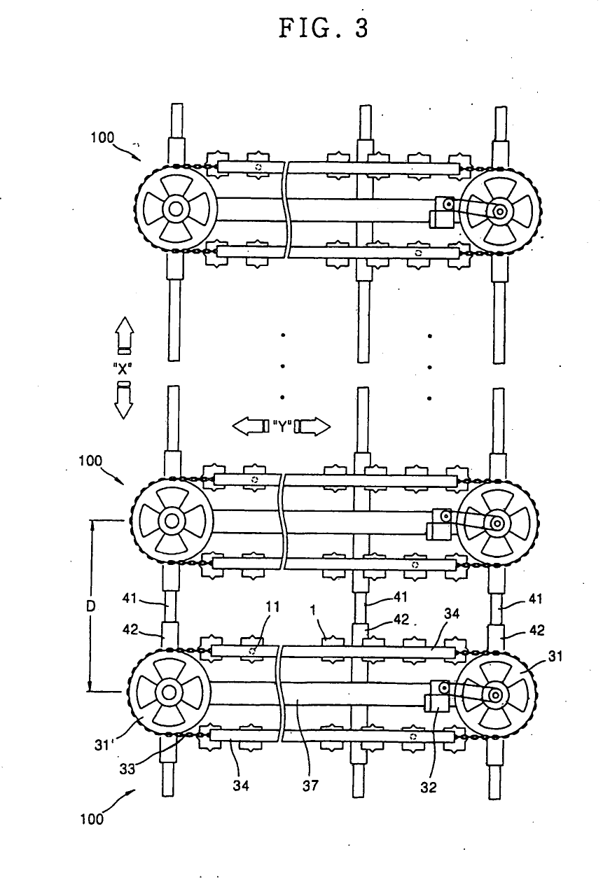

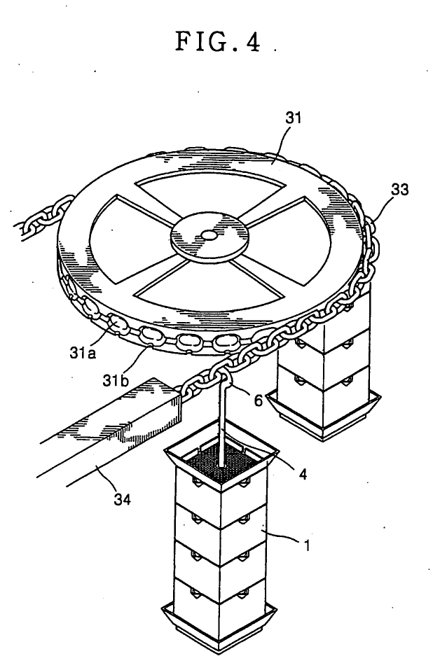

Means for installing the nutriculture pot 1 on the chain conveyor 100 will now be described. As shown in FIGS. 3 and 4, a hoist chain 33 is used as a chain conveyor according to the illustrative embodiment. In other words, the nutriculture pot 1 is installed on the hoist chain 33 of the chain conveyor 100. An upper end hook 6 of a wire rope 4 fixing the nutriculture pot 1 is hung on a link of the hoist chain 33. Here, when the hoist chain 33 is wound up on the chain wheel 31 and is rolled, interference preventing slots 31b are formed below the teeth 31a of the chain wheel 31 so that the hook 6 of the wire rope 4 is not interfered with the teeth 31a formed on the outer circumference of the chain wheel 31. The “C”-shaped pipe 34 for guiding the hoist chain 33, has a lower portion opened to provide a moving path of the wire rope 4 of the nutriculture pot 1.

The nutriculture device according to the illustrative embodiment operates as follows.

The plurality of nutriculture pots 1 are hung and fixed on the hoist chain 33 of the chain conveyor 100 at a predetermined distance. If the motor 32 of the chain conveyor 100 is driven, the hoist chain 33 suspending the nutriculture pot 1 move along a predetermined closed loop type track in a circulating manner. At the same time, when a spray nozzle 11 installed at a predetermined position of the moving track of the nutriculture pot 1 is operated, the nutrient solution is periodically supplied to the nutriculture pot 1 having arrived thereat. The nutrient solution discharged from the nutriculture pot 1 is recovered by the nutrient solution recovery channel 12 installed in the lower portion of the system.

In the case where a multitude of integrated chain conveyors 100 are arranged in a houseplant for the purpose of facilitating efficient space utilization, a distance D between neighboring conveyors is reduced, resulting in worker's inconvenience due to a reduced working space. In this case, the handle 48 of the distance adjusting means may be rotated manually by the worker to cause interaction between the pinion gear 45 fixed on the shaft 44 and the rack gear 46, thereby generating a driving force in the direction “X”. Accordingly, the plurality of roller members 42 installed at the lower end of the chain conveyor 100 move along the rails 41 so that the chain conveyor 100 eventually move in the direction “X”. In such a manner, the worker can arbitrarily adjust the distance D between conveyors.

Although the illustrative embodiment has shown that the chain conveyors are employed as the moving means of the nutriculture pot, rope driving means or belt driving means may also be used. Also, although the illustrative embodiment has shown that the motor 32 transmits power only to the driving chain wheel 31, specifically in the case where the chain conveyor system is considerably long, the motor 32 may be configured such that it transmits power to both the driving chain wheel 31 and the driven chain wheel 31′ for facilitating a driving. Also, according to the illustrative embodiment, the worker manually operates the distance adjusting means of moving the conveyers in the direction “X” by rotating the handle 48. However, the nutriculture device may be configured such that the distance between conveyors can be automatically adjusted by means of power generating means such as a motor. Further, according to the present invention, any connection structure other than the aforementioned rack-pinion connection structure can also be used as the power transmission means.

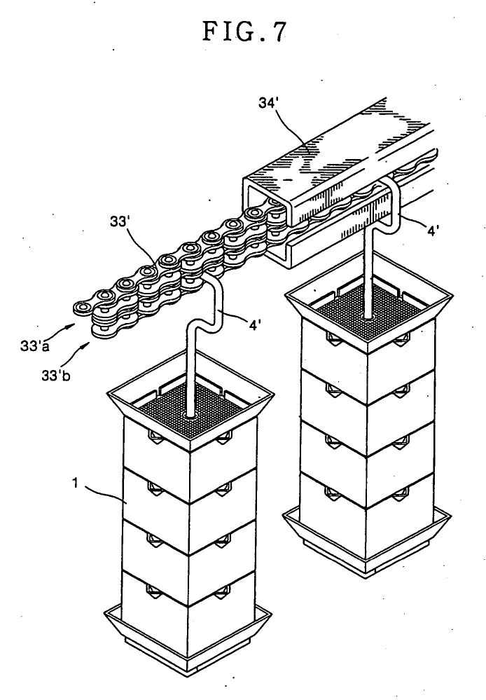

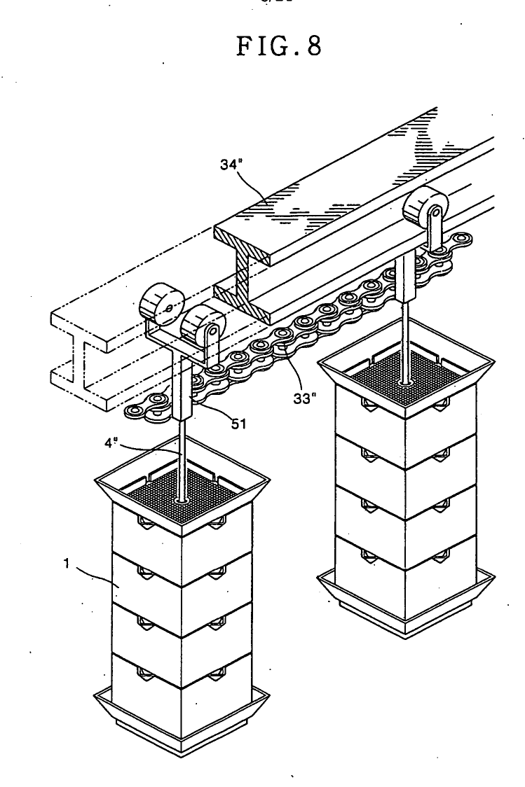

Nutriculture devices according to second and third embodiments of the present invention will now be described with reference to FIGS. 7 and 8.

The nutriculture device according to the second embodiment as shown in FIG. 7 uses a chain conveyor employing chains 33′ in which link plates are continuously connected to each other by means of pins. Particularly, in this embodiment, multi-row chains are used. In detail, the first row chain 33′a positioned at the upper row is interlocked with sprackets (not shown) of the chain wheel disposed at opposite ends of the chain, and the second row chain 33′b positioned at the lower row is fixed to the upper end of the wire rope 4′ fixing the nutriculture pot 1. Also, according to the illustrative embodiment, a lateral surface of the “C”-shaped pipe 34′ which guides the movement of the chain 33′ is opened, and the wire rope 4′ is bent in a “U” shape accordingly.

The nutriculture device according to the third embodiment as shown in FIG. 8 employs an “I”-shaped beam 34″ as a member for guiding movement of chains 33′. Roller members 51 are provided at both sides of the “I”-shaped beam 34′ so as to be movable in a lengthwise direction of the “I”-shaped beam 34″. A rope 4″ which fixes the nutriculture pot 1 is coupled to the roller members 51. The chains 33″ are coupled to the roller members 51 by general connection means (not shown) so that the roller members 51 move along a predetermined track in a circulating manner according as the chains 33″ move.

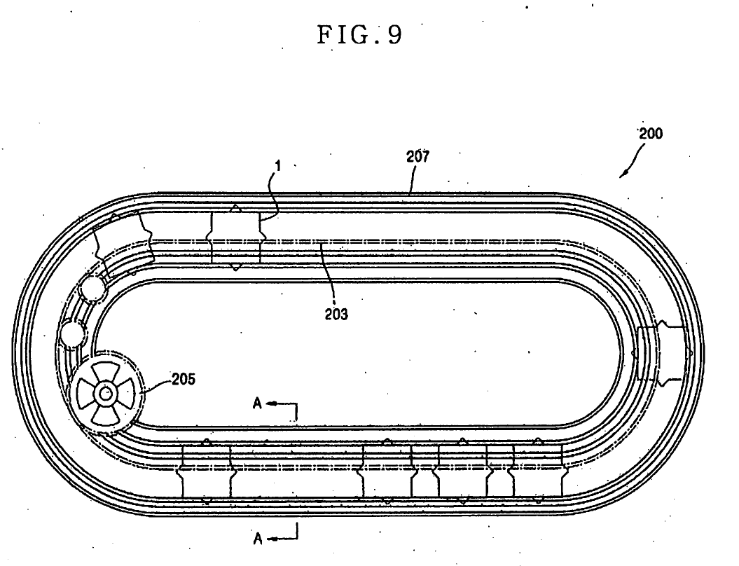

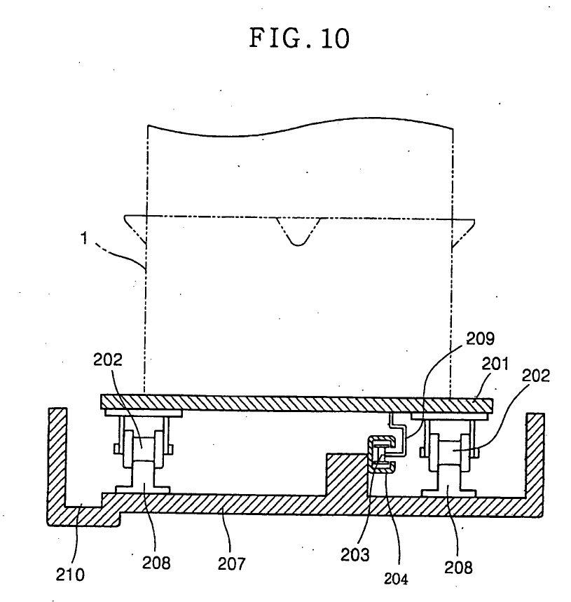

A nutriculture device according to a fourth embodiment of the present invention will now be described with reference to FIGS. 9 through 11.

Unlike in the embodiments shown in FIGS. 2 through 6, the nutriculture device according to the fourth embodiment is configured such that a closed loop type chain conveyor 200 is installed on the ground surface and a nutriculture pot 1 is seated on a pallet 201 positioned above a chain conveyor 200 to move with the pallet 201. In detail, the chain conveyor 200 includes a frame 207, two guide rails 208, rollers 202, a “C”-shaped pipe 204, a fixing member 209, and a chain wheel 205. The frame 207 extends along a moving is track of the nutriculture pot 1. The guide rails 208 are installed on the frame 207. The rollers 202 moves along the guide rails 208, respectively and the pallet 201 is fixedly installed thereon. The “C”-shaped pipe 204 is installed in the frame 207 and guides movement of a chain 203. The fixing member 209 connects the chain 203 and pallet 201 to each other. The fixing member 209 is driven by driving means (not shown) and the chain 203 is wound therearound to then be connected.

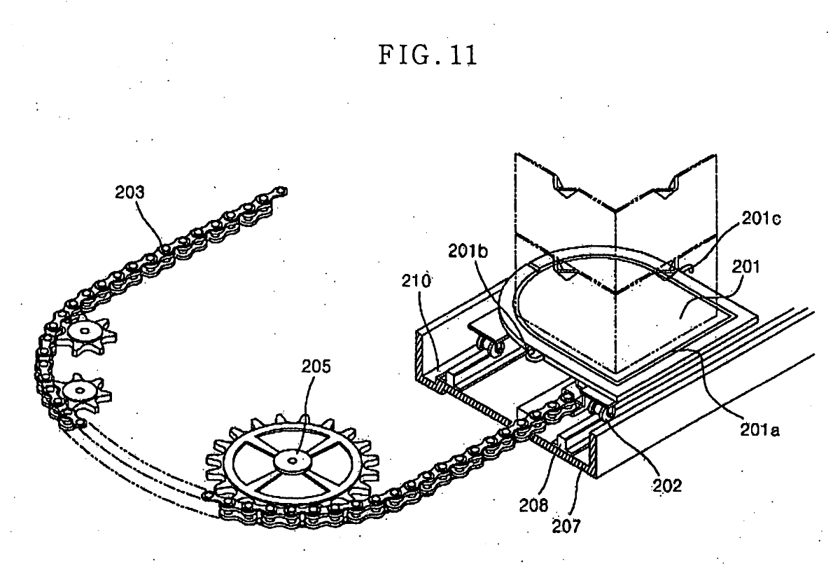

When the pallet 201 on which the nutriculture pot 1 is seated passes by a curved portion of the moving track, that is, a portion where the chain wheel 205 is positioned, as shown in FIG. 11, it may be interfered with the neighboring pallet. In order to prevent the interference, the pallet 201 has a chamfer formed at a portion facing the center of the curvature of radius of the curved portion. In order to prevent the pallet from fluctuating during movement, a hook 201b and a locker 201c for connecting adjacent pallets are provided at opposite ends of the pallet 201, respectively.

Also, a groove 210 is formed at one side of the frame 207 to collect the nutrient solution drained from the nutriculture pot 1. In this regard, a groove 201a is formed along the periphery of the pallet 201 to allow the nutrient solution drained from the nutriculture pot 1 to be induced to the groove 210 of the frame 207 disposed at the lower portion of the pallet 201.

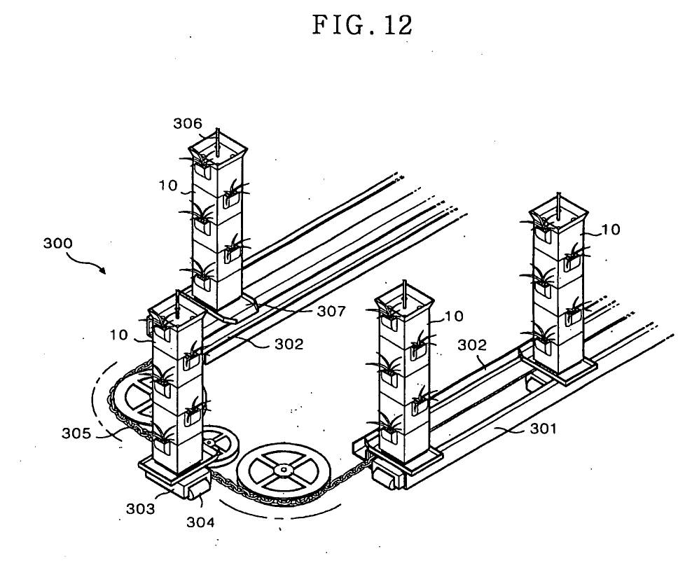

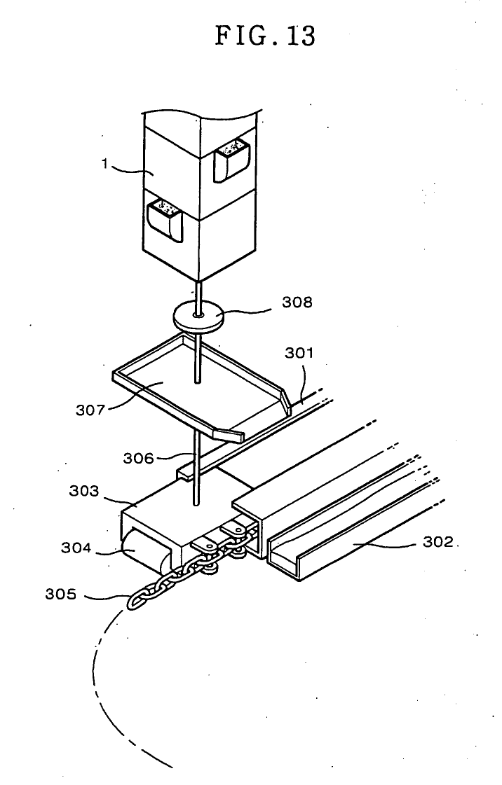

A nutriculture device according to a fifth embodiment of the present invention will now be described with reference to FIGS. 12 and 13.

According to this embodiment, a nutriculture device 300 includes a “C”-shaped frame 301 extending along a closed loop type track. A drain duct 302 extending in parallel with a frame 301 is installed inside the frame 301. In the frame 301 are installed a plurality of moving member 303 each having a roller 304 and spaced a predetermined distance apart from each other and move on the frame 301. The moving member 303 is connected to a chain 305 by a general connection mechanism and move according as the chain 305 moves. The moving member 303 includes a support rod 306 extending substantially perpendicularly to support a pallet 307 and a nutriculture pot 1, which will later be described. The pallet 307 is fixedly installed on the moving member 303 and the nutriculture pot 1 is seated on the pallet 307. A thrust is bearing 308 is interposed between the pallet 307 and the nutriculture pot 1 to allow the nutriculture pot 1 to be capable of freely rotating thereat. Thus, even if the nutriculture pot 1 is obstructed during moving, it is pivotally rotated ordinarily by means of the thrust bearing 308, thereby minimizing interference by obstacles.

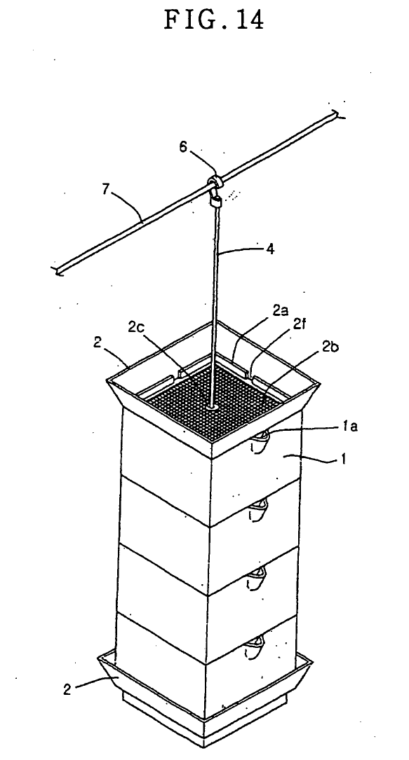

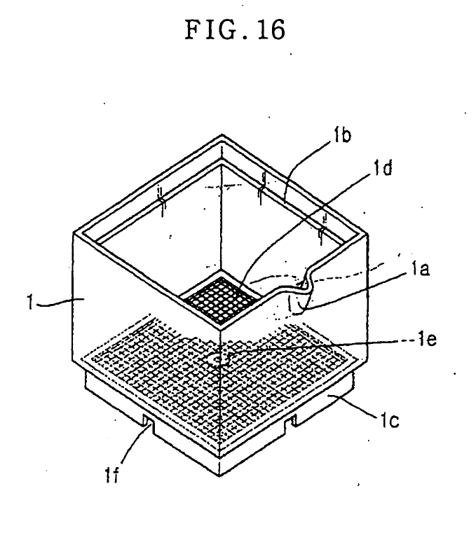

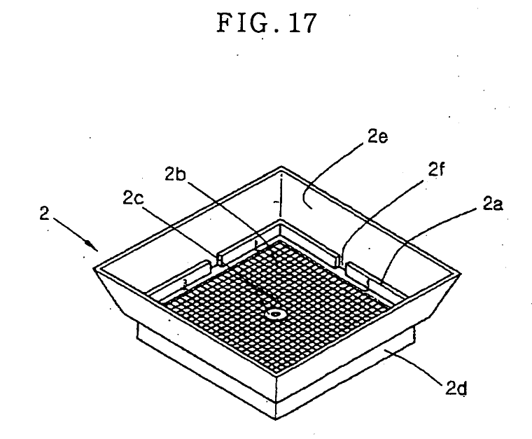

Now, various embodiments of a stack-type nutriculture pot system according to the present invention will be described in detail with reference to FIGS. 14 through 20.

The stack-type nutriculture pot system according to a first embodiment of the present invention shown in FIGS. 14 through 17 is constructed by stacking a plurality of nutriculture pots 1. Each of the plurality of nutriculture pots 1 is shaped of a cylinder having a rectangular cross section and having upper and lower ends opened. A lower network 1d for holding culture soil 3 is installed at the lower end of the nutriculture pot 1, and crop growth units 1a are formed at lateral surfaces of the nutriculture pot 1. The crop growth units 1a allows seeds of the crop to be easily bedded in the culture soil 3 and provides for a space for leaves of the crop having grown in the culture soil 3 to spread toward the outside of the nutriculture pot 10.

A rope throughhole 1e is formed at the center of the lower network 1d of the nutriculture pot 1. A wire rope 4 for fixedly suspending the stack-type nutriculture pot system, passes through the rope throughhole 1e.

An upper sill 1b is formed at the upper portion of the nutriculture pot 1 and a lower sill 1C is formed at the lower portion of the nutriculture pot 1. Sizes of the upper sill 1b and the lower sill 1c are so set such that they are interlocked to each other when stacking the plurality of nutriculture pots. Pot weep holes 1f are provided at the bottom periphery of the lower sill 1c of the nutriculture pot 1.

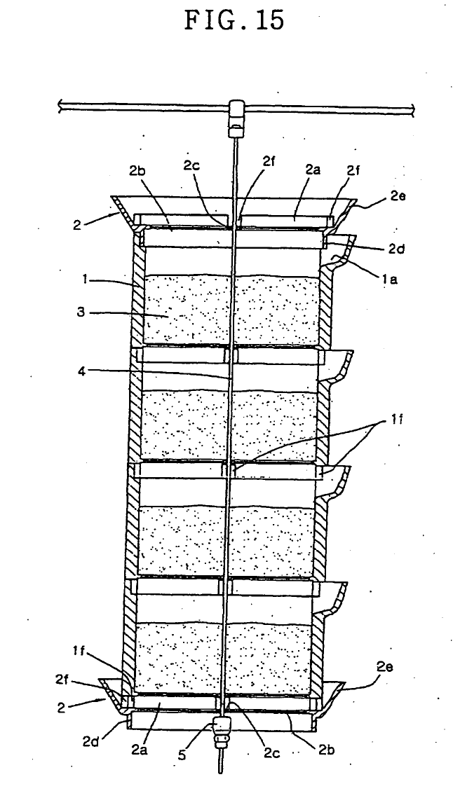

As shown in FIG. 15, an upper cover 2 is provided at the upper portion of the uppermost nutriculture pot of the stack-type nutriculture pot system. A lower cover having the same shape as and denoted by the same numeral as the upper cover 2, is provided at the lower portion of the lowermost nutriculture pot. The upper and lower covers 2 are rectangular corresponding to the shape of the nutriculture pot 1, and are shaped of a hopper 2e, that is, its cross-sectional area tapers downward. A cover network 2b is installed on each bottom of the upper and lower covers 2, and a rope fastening hole 2c is formed at the center of the cover network 2b. A cover upper rim 2a is formed at the upper portion of the lower cover 2, the cover upper rim 2a being coupled to the lower sill 1c of the nutriculture pot 1 to be stacked on the lower cover 2. A cover lower rim 2d coupled to the upper sill 1b, under which the nutriculture pot 1 is to be disposed, is provided at the lower portion of the upper cover 2. Cover weep holes 2f are formed in the cover upper rim 2a.

The cover weep holes 2f of the upper and lower covers 2 and the pot weep holes 1f are connected to each other to provide for a path ranging from the top portion of the stacked nutriculture pots to the bottom thereof. The path leads downward the nutrient solution staying at the outer circumferential surface of the hopper 2e of the upper cover 2.

The operation and effects of the aforementioned stack-type nutriculture pot system according to the first embodiment of the present invention are described below.

A plurality (four in the illustrative embodiment) of nutriculture pots 1 each containing culture soil 3 are sequentially stacked, and upper and lower covers 2 are mounted on and beneath of the stack-type nutriculture pot system 1, respectively. A wire rope 4 penetrates rope throughholes 1e of the nutriculture pot 1 and rope fastening holes 2c of the upper and lower covers 2. Then, the lower end of the wire rope 4 is fixed to the lower cover 2 using a wire rope stopper 5. The stack-type nutriculture pot system 1 is hooked on transmission means, e.g., the conveyor 7, using a hook 6 provided at the upper portion of the wire rope 4, to then be fixed.

As described above, the nutrient solution applied to the upper cover 2 of the stack-type nutriculture pot system by means of the spray nozzle is delivered to the uppermost nutriculture pot 1 via the upper cover network 2b, so that it is supplied to the crop planted in the culture soil and then flows out through the bottom lower network 1d. The flown nutrient solution is then led to the nutriculture pot 1 in the next column. In such a manner, the nutrient solution can be delivered to all the nutriculture pots stacked in multiple columns.

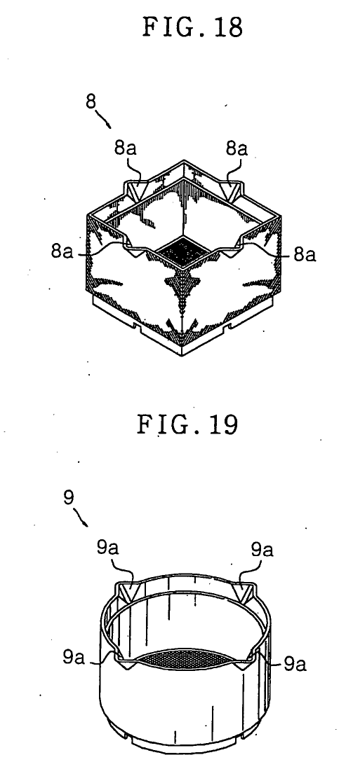

Each of nutriculture pots 8 constituting a stack-type nutriculture pot system according to a second embodiment of the present invention, as shown in FIG. 18, has four crop growth units 8a formed at rectangular lateral surfaces, respectively. Referring to FIG. 19, each of nutriculture pots 9 constituting a stack-type nutriculture pot system according to a third embodiment of the present invention has a circular cross section having four crop growth units 9a formed along its perimeter.

Nutriculture pots constituting the stack-type nutriculture pot system according to the present invention are not limited to ones illustrated in the specification and drawings, and may take various shapes according to use conditions, for example, a triangular or hexagonal. The number of crop growth units formed at lateral surface of each nutriculture pot can also be changed in various ways according to conditions and environments of a cultivation plant.

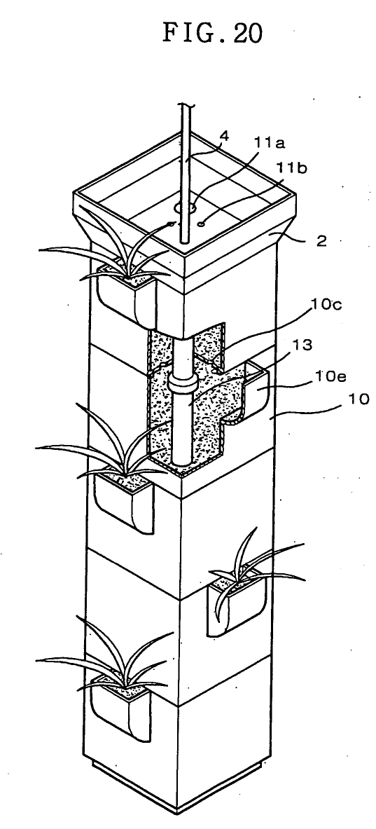

A stack-type nutriculture pot system according to a fourth embodiment of the present invention will now be described with reference to FIGS. 20 through 22.

The stack-type nutriculture pot system according to a fourth embodiment of the present invention is formed by stacking a plurality of nutriculture pots 10 each having culture soil 30 for supporting a crop. Each of the plurality of nutriculture pots 10 is shaped of a cylinder having an upper end opened and a lower end closed.

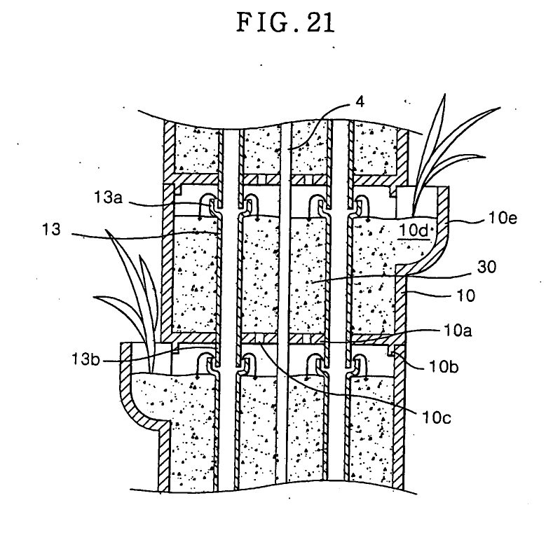

The nutriculture pot 10 has one or more nutrient supply ducts 13 installed therein. Each of the nutrient supply ducts 13 has its lower end penetrate a bottom surface 10a of the nutriculture pot 10 to be installed substantially perpendicularly. The nutrient supply ducts 13 of two vertically neighboring nutriculture pots 10 are connected to each other by stacking the plurality of nutriculture pots. An expanded portion 13a having an expanded cross section is formed at a lower end of each nutrient supply duct 13. Thus, an outlet (corresponding to a portion indicated by arrows in FIG. 21) is provided at a connection portion between the expanded portion 13a and an upper end of the neighboring nutrient supply duct so that a nutrient solution contained in the nutrient supply duct flows out therethrough. Although not shown, the lower end of the nutrient supply duct installed at the lowermost nutriculture pot is closed so that the nutrient solution supplied from the upper nutriculture pots is stored inside the interconnected nutrient supply ducts.

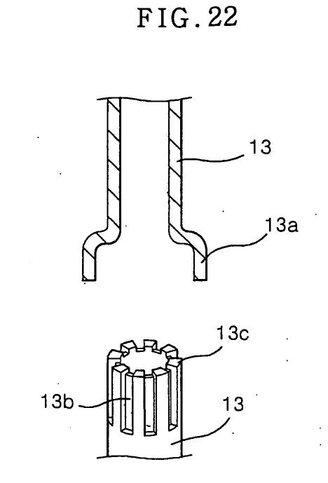

As shown in FIG. 22, in order to prevent a nutrient solution outlet from clogging due to a contact between the upper end and the lower end of two neighboring nutrient supply ducts 13, a plurality of grooves 13b are formed lengthwise at the upper end of the nutrient supply duct 13, and a plurality of surface roughness portions 13c are formed along the circumferential direction of the upper end. Therefore, even if two nutrient supply ducts may contact each other due to a fabrication error or an assembly error, the nutrient solution stored in the nutrient supply ducts can flow out via a gap formed by the surface roughness portions 13c and the grooves 13b.

An upper cover 2 is coupled to the upper portion of the uppermost nutriculture pot. The upper cover 2 is shaped of a hopper, and has nutrient supply holes 11a formed at locations corresponding to the nutrient supply ducts 13. Also, a plurality of weep holes 11b are formed on the bottom surface of the upper cover 2.

One or more weep holes 10c are formed on the bottom surface 10a of each nutriculture pot 10. Reference mark 10b denotes a connection sill for setting connection positions of the nutriculture pots 10 when stacking the same.

Crop growth units 10d are formed at one or more lateral surface of the nutriculture pot 10. Sizes of the crop growth units are set to be large enough to allow leaves of the crop having grown in the culture soil to spread toward the outside of the nutriculture pot. An outer circumferential surface 10e defining the crop growth units 10d is smoothly curved upward so that the crop can grow upward in a natural way.

If a nutrient solution is supplied from the upper portion of the stack-type nutriculture pot system according to the illustrative embodiment through a spray nozzle, the nutrient solution fills the plurality of nutrient supply ducts 13 upward from the bottom to the top of the system via the nutrient supply holes 11a of the upper cover 2. The nutrient solution stored in the nutrient supply ducts 13 flows out through outlets to then be supplied to the nutriculture pots 10 of the respective columns. The supplied nutrient solution is drained downward through the weep holes 10c formed on the bottom surface 10a of the nutriculture pot 10.

In the above-described stack-type nutriculture pot system, the number of stacked columns of nutriculture pots can be arbitrarily adjusted according to a ceiling height of a houseplant, and the growth process of the crop can be observed by lifting the columns while the nutriculture is being carried out. Therefore, since the houseplant can be utilized in a space-efficient manner, the crop can be cultivated in high densities.

In the nutriculture device according to the present invention, since nutriculture pots, in which crops are bedded, change their positions in a house plant at regular intervals, the amount of sunshine incident to the crops can be uniformly maintained without adaptively changing directions of sun shield equipment, thereby contributing to even growth of the crops.

Also, according to the present invention, since it is not necessary to install a separate nutrient irrigation facility for every nutriculture pot, the installation cost can be advantageously reduced. Further, since a nutrient solution flowing out from the nutriculture pot is recycled by means of a nutrient solution recovery channel, unnecessary consumption of the nutrient solution can be avoided.

1. A stack-type nutriculture pot system formed by stacking a plurality of nutriculture pots each having culture soil for supporting a crop, wherein each of the plurality of nutriculture pots is shaped of a cylinder having a rectangular cross section and having upper and lower ends opened, and a lower network for holding culture soil is installed at the lower end of the nutriculture pot, so that a nutrient solution supplied from an upper portion of the stack-type nutriculture pot system is delivered from the uppermost nutriculture pot to the lowermost nutriculture pot, and wherein crop growth units are formed at one or more lateral surfaces of the nutriculture pot.

2. A stack-type nutriculture pot system formed by stacking a plurality of nutriculture pots each having culture soil for supporting a crop, wherein each of the plurality of nutriculture pots is shaped of a cylinder and having an upper end opened and a lower end closed, and has one or more nutrient supply ducts penetrate a bottom surface thereof to be installed substantially perpendicularly, so that the nutrient supply ducts of two vertically neighboring nutriculture pots are connected to each other when stacking the plurality of nutriculture pots, an outlet is provided at a connection portion between two neighboring nutrient supply ducts so that a nutrient solution contained in the nutrient supply duct flows out there through, and wherein crop growth units are formed at one or more lateral surfaces of the nutriculture pot.

3. The stack-type nutriculture pot system of claim 1, wherein the crop growth units are as large as they allow leaves of the crop having grown in the culture soil to spread toward the outside of the nutriculture pot.

4. The stack-type nutriculture pot system of claim 1, further comprising an upper cover at the upper portion of the uppermost nutriculture pot of the stack-type nutriculture pot system, the upper cover being shaped of a hopper, in which its cross-sectional area tapers downward.

5. The stack-type nutriculture pot system of claim 1, wherein a rope throughhole is formed substantially at centers of the plurality of nutriculture pots and the upper cover, the system further comprising a wire rope passing through the rope throughhole, for integrally fastening the plurality of nutriculture pots.

6. A nutriculture device comprising:
moving means for periodically moving a plurality of nutriculture pots, each having culture soil for supporting a crop, on a predetermined closed loop type moving track;
a spray nozzle installed at a location on the moving track of the nutriculture pots, for supplying a nutrient solution to the nutriculture pot passing through the location; and
a nutrient solution recovery channel for recovering the nutrient solution flowing from the nutriculture pot.

7. The nutriculture device of claim 6, wherein the moving means comprises chain conveyors arranged at a predetermined height from the ground on the moving track of the plurality of nutriculture pots, and the nutriculture pots being spaced a predetermined distance apart from each other and suspended on the chain conveyors to be transported along the moving track.

8. The nutriculture device of claim 6, wherein the moving means comprises chain conveyors arranged on the ground on the moving track of the plurality of nutriculture pots, and the nutriculture pots being seated on a plurality of pallets spaced a predetermined distance apart from each other on the chain conveyors

9. The nutriculture device of claim 8, wherein a thrust bearing is interposed between each of the pallets and each of the nutriculture pots to allow the nutriculture pots to be capable of freely rotating thereat.

10. The nutriculture device of claim 7, comprising two or more closed loop type chain conveyors arranged in a direction substantially perpendicular to the moving direction of the nutriculture pots, and distance adjusting means for adjusting a distance between the neighboring closed loop type chain conveyors.

11. The nutriculture device of claim 10, wherein the distance adjusting means comprises:
one or more rails disposed in a direction substantially perpendicular to the moving direction of the nutriculture pots;
one or more roller members for supporting the chain conveyors and configured to roll along the rails; and
driving mechanism for providing the chain conveyors with a driving force in the rail direction.

12. The stack-type nutriculture pot system of claim 2, wherein the crop growth units are as large as they allow leaves of the crop having grown in the culture soil to spread toward the outside of the nutriculture pot.

13. The stack-type nutriculture pot system of claim 2, further comprising an upper cover at the upper portion of the uppermost nutriculture pot of the stack-type nutriculture pot system, the upper cover being shaped of a hopper, in which its cross-sectional area tapers downward.

14. The stack-type nutriculture pot system of claim 2, wherein a rope throughhole is formed substantially at centers of the plurality of nutriculture pots and the upper cover, the system further comprising a wire rope passing through the rope throughhole, for integrally fastening the plurality of nutriculture pots.
